(19) United States
(12) Patent Application Publication
(10) Pub. No.: US 2025/0180289 A1
(43) Pub. Date: Jun. 5, 2025

(54) CRYO-DRYING PLANT

(71) Applicants: Niccolò LE BRUN, Firenze (IT); Guglielmo Enrico GIACALONE AMORELLI, Faenza (Ravenna) (IT)

(72) Inventors: Niccoló LE BRUN, Firenze (IT); Marco LE BRUN, Brisighella (Ravenna) (IT); Massimo PELLIZZARI, Brisighella (Ravenna) (IT); Guglielmo Enrico GIACALONE AMORELLI, Faenza (Ravenna) (IT)

(21) Appl. No.: 18/843,941

(22) PCT Filed: Mar. 9, 2023
(86) PCT No.: PCT/IB2023/052239

§ 371 Date: Sep. 4, 2024

(30) Foreign Application Priority Data
Mar. 16, 2022 (IT) 102022000005081

(51) Int. Cl. F26B 5/06; F25B 40/02; F25B 41/42; F26B 9/06

(52) U.S. Cl. CPC F26B 5/06; F25B 40/02; F25B 41/42; F26B 9/066

(57) ABSTRACT

Lyophilization plant configured to remove a substance from a product to be lyophilized, comprising a lyophilization tank and a closed-loop refrigeration system, coupled to the lyophilization tank and operated by a carrier fluid. The refrigeration system includes a carrier fluid expansion unit, a first heat exchanger, a carrier fluid compression unit, and a main flow regulating member of the carrier fluid. The main flow regulating member has an inlet opening in fluid communication with the compression unit, a first discharge opening connected to a first branch and a second discharge opening connected to a second branch, parallel to the first branch. The main flow regulating member is configured to regulate and determine respective amounts of carrier fluid conveyed in the first branch and in the second branch so as to obtain a plurality of operating configurations of the lyophilization plant.

The present invention relates to a lyophilization plant.

The present invention relates to the pharmaceutical and food sector and finds particular application in emerging sectors such as nutraceuticals and superfoods.

As is known, the process of lyophilization, also called cryo-drying, consists of the removal of a substance to be sublimated from a product by freezing and sublimation.

This substance to be sublimated is typically water in the case of food products. However, in the pharmaceutical sector the substance to be sublimated can be any type of solvent, such as water or alcohol.

Further, the product may be any organic or inorganic matter having a certain amount of such substance to be sublimated.

The lyophilization process is used to preserve the product by removing the substance and preventing degradation.

As is known, the product to be processed is evenly distributed on trays that are placed on the shelves inside a lyophilization tank.

The lyophilization process is typically conducted in three phases: a freezing phase, a primary drying phase, and a secondary drying phase.

The product is either already frozen or is frozen directly on the shelves by means of a cold fluid that flows in the shelves.

Subsequently, the tank is evacuated to reduce the internal pressure so as to make it lower than the pressure value at the triple point of the substance to be removed. If the substance is water, the pressure inside the tank is brought to approximately 0.1 mbar absolute by means of a vacuum system.

During the primary drying, the product is heated and the crystals of the frozen substance sublimate from solid to vapor, resulting in a dehydrated product.

The sublimated or desorbed vapor is condensed in a cold trap, consisting of a cold surface inside the lyophilization tank or in a collection volume connected to it.

If the substance to be sublimated is water, the temperature of the cold trap is usually lower than −35° C.

The primary drying phase is followed by a secondary drying phase in which the last molecules of the substance bound to the dried product are removed.

In this secondary drying phase, the product is further heated, and the temperature is increased until a desired temperature is reached indicative of the end of the desorption process.

The final product contains only a minimal amount of the substance compared to the amount initially present in the product and, when packaged in an inert environment, undergoes minimal or no degradation.

In the case of a food product, for example, the removal of water ensures the absence of bacterial proliferation.

At the end of the lyophilization process, the condensed vapor in the cold trap is removed in a defrosting phase.

From the constitutive point of view, a lyophilization plant of a type known in the technical field pertaining to the present invention comprises a lyophilization tank, a refrigeration system, and a heating circuit.

The lyophilization tank includes a vacuum pump for evacuating air and one or more shelves for collecting the product to be lyophilized.

The refrigeration system is usually composed of four main components: a compressor, a condenser, an expansion valve arranged outside the tank and a cold evaporator where the sublimated substance condenses.

The heating circuit may comprise an electrical circuit configured to provide heat to the shelves by means of resistors fixed on the shelves themselves or by means of an irradiation system.

Alternatively, the heating circuit may comprise a pump which circulates a hot auxiliary fluid through a heater, typically a boiler or an electrical resistor, and then through the shelves.

The lyophilization systems of the known type still have some structural, operational and economic/productive disadvantages which make the use thereof problematic.

Firstly, the power consumption of a lyophilization plant of the known type is extremely high.

The high energy consumption is in fact mainly linked to the extraction of heat in the cold trap and, above all, to the supply of heat for the primary drying and secondary drying phases.

In particular, with regard to the extraction of heat in the cold trap, known lyophilization plants use a refrigeration system based on direct evaporation inside the cold trap or by cooling a secondary fluid which then serves as a cooling medium for the cold trap.

On the other hand, with regard to the supply of heat for the primary drying and secondary drying phases, they are extremely energy-intensive: in commercial lyophilization, according to the prior art, the heat to be supplied to the product is in fact the main factor responsible for the energy consumption.

In both direct and radiative heating as well as heating by means of hot auxiliary fluid, the energy supplied to heat the product ultimately comes from an electrical heater or a fossil fuel burner (typically natural gas).

Since energy costs significantly affect the costs of the final products, a need strongly felt in the technical field pertaining to the present invention is to reduce energy consumption.

Due to these costs, in fact, the lyophilization process can be used only for a limited group of products.

Over the years, several publications have addressed the problem of energy efficiency of lyophilization plants in order to reduce the energy costs of the lyophilization process, providing improved lyophilization plants.

Examples of plants from such publications can be found in the following documents: US201615260539 and U.S. Pat. Nos. 4,407,140, 10,113,797.

Nevertheless, even in their most modern implementations, these lyophilization plants of the known type have some structural, operational and/or economic/productive disadvantages which make the use thereof problematic.

In this context, the technical task of the present invention is to provide a lyophilization plant which does not present the same drawbacks inherent in the currently known art.

Nevertheless, the object of the present invention is to provide a lyophilization plant which guarantees a reduced energy consumption and which, at the same time, maintains a compact and simplified structure.

A further object of the present invention is to provide a lyophilization plant which is extremely efficient.

Another object of the present invention is to provide a lyophilization plant which reduces the energy costs of the process so as to reduce the final cost of the product and so as to broaden the application of the lyophilization process.

The specified technical task and the specified objects are substantially achieved by a lyophilization plant that is the object of the present invention, as detailed in the contents of the claims below and/or in the contents of the present disclosure.

In particular, the specified technical task and the specified objects are substantially achieved by a lyophilization plant in accordance with the present invention.

The plant is configured to remove a substance from a product to be lyophilized or freeze-dried.

In the present disclosure, the term “product” is intended to mean any organic or inorganic matter having a substance therein to be removed by sublimation.

According to a non-limiting example, the product may be a food product. In such an example, the substance to be removed may be water.

According to a further non-limiting example, the product may be a pharmaceutical product. In particular, the substance to be removed may be any kind of solvent, such as water or alcohol.

However, to facilitate the present disclosure, the term “substance” shall preferably be understood to mean water.

The plant comprises a lyophilization tank and a refrigeration system.

The lyophilization tank has a containment volume.

The lyophilization tank comprises one or more shelves operatively arranged within the containment volume and configured to support the product.

According to one example, the one or more shelves are arranged within a portion of the containment volume that is raised with respect to a bottom of the containment volume.

In a preferred but non-limiting manner, moreover, the plant may comprise a plurality of trays insertable in the containment volume so as to facilitate the transport and positioning of the product inside the tank.

Preferably, the lyophilization tank comprises a vacuum pump configured to maintain the containment volume in a vacuum condition. The term “vacuum condition” is intended to mean that the vacuum pump is configured to maintain a pressure value within the containment volume lower than a pressure value of the triple point of the substance to be removed.

According to one example, the term “vacuum condition” is intended to mean that the vacuum pump is configured to maintain a pressure value within the containment volume lower than a pressure value of the triple point of water.

According to one aspect, the lyophilization tank is operatively coupled to the refrigeration system.

The refrigeration system is of the closed-loop type and operates by means of a carrier fluid.

The carrier fluid may be a generic fluid employed in refrigeration cycles.

The carrier fluid may be an artificial fluid, such as chlorinated refrigerant fluids (CFCs, HCFCs, HFCs, PFCs) or hydrofluoroolefin refrigerant fluids (HFOs). Further, the carrier fluid may be a natural fluid, such as ammonia, carbon dioxide, etc.

According to a preferred but non-limiting embodiment, the carrier fluid is either R404A or R452A.

The refrigeration system comprises a carrier fluid expansion unit.

The expansion unit is configured to conduct a lamination on the carrier fluid. In particular, the expansion unit is configured to promote a decrease in pressure of the carrier fluid and to promote a decrease in temperature of the carrier fluid.

According to one example, the expansion unit comprises one or more lamination valves.

The refrigeration system includes a first heat exchanger arranged downstream of the expansion unit.

In the present description, the term “downstream” is intended to mean that a component of the refrigeration system is arranged to follow a further component of the refrigeration system, taking as reference the direction of travel of the carrier fluid within the refrigeration system.

Furthermore, the term “upstream” is intended to mean that a component of the refrigeration system is arranged before a further component of the refrigeration system, taking as reference the direction of travel of the carrier fluid within the refrigeration system.

According to one example, the first heat exchanger may be operatively inserted into the containment volume. In such an example, the first heat exchanger is arranged in a portion of the containment volume other than the portion in which the one or more shelves are arranged. Preferably, the first heat exchanger is arranged in a bottom of the containment volume.

According to a further example, the first heat exchanger can be operatively inserted into a further containment volume, adjacent to and communicating with the containment volume of the lyophilization tank.

The first heat exchanger is configured to promote thermal exchange between the carrier fluid and the containment volume.

In particular, the first heat exchanger is configured to determine at least one cooling of the containment volume.

In other words, the first heat exchanger operates at least as a “cold trap” of the substance which during the lyophilization process is dispersed within the containment volume in a gaseous state and/or in a vapor state and which, by means of such first heat exchanger, freezes on the external walls of the first heat exchanger and/or on the walls of the lyophilization tank adjacent to the first heat exchanger.

At the same time, the first heat exchanger promotes at least one state change of the carrier fluid from liquid to gas.

The refrigeration system comprises a carrier fluid compression unit, arranged downstream of the first heat exchanger.

The compression unit is configured to determine a compression on the carrier fluid. In other words, the compression unit is configured to promote an increase in pressure of the carrier fluid and to promote an increase in temperature of the carrier fluid.

The compression unit may comprise a compressor.

According to one example, the compression unit comprises a multistage compressor having a first stage and at least one second stage.

According to a further example, the compression unit comprises a first single-stage compressor and at least one second single-stage compressor arranged in series with the first single-stage compressor.

According to a further example, the compression unit comprises a single single-stage compressor.

Advantageously, as will be clearer in the remainder of the present description, the use of a high compression ratio makes available a carrier fluid at a high temperature for the benefit of the efficiency of the entire lyophilization plant.

According to one aspect of the present invention, the refrigeration system comprises a main flow regulating member of the carrier fluid, arranged downstream of the compression unit.

According to one example, such main flow regulating member comprises a three-way valve.

The main flow regulating member has an inlet opening in fluid communication with the compression unit, a first discharge opening connected to a first branch and a second discharge opening connected to a second branch, parallel to the first branch. The first and the second branch are connected in a connecting node upstream of the compression unit. According to one example, the connecting node is arranged downstream of the expansion unit.

In particular, the first branch comprises an external heat exchanger configured such that the carrier fluid yields heat to an external thermal source. In other words, the external heat exchanger is configured to promote an exchange of heat between the carrier fluid and the external thermal source.

The term “external thermal source” is intended to mean a generic physical system that has a lower temperature than the temperature of the carrier fluid arriving from the first branch. Such an external thermal source may, for example, be a cold external fluid.

Functionally, the external heat exchanger is configured to determine at least a cooling of the carrier fluid and a state change of the carrier fluid from gaseous to liquid.

Structurally, the external heat exchanger can be equipped with electric fans. Advantageously, this feature allows a precise regulating of the refrigeration system as well as a greater stability of the refrigeration system itself.

The second branch comprises a second heat exchanger, connected to the one or more shelves and configured such that the carrier fluid yields heat to the one or more shelves. Functionally, the heat exchanger is configured to provide heat to the at least one or more shelves so as to cause heating of the one or more shelves and, consequently, of the product stored thereon. Functionally, the second heat exchanger is configured to determine at least a cooling of the carrier fluid and a state change of the carrier fluid from gaseous to liquid.

The main flow regulating member is configured to regulate and determine respective amounts of carrier fluid conveyed in the first and in the second branch so as to obtain a plurality of operating configurations of the lyophilization plant.

Advantageously, the refrigeration system alone is able to provide the entire heat requirement necessary for the lyophilization process of the product. This caloric requirement is substantially provided by the compression unit of the refrigeration system.

In other words, the energy obtained from the refrigeration system is able to be used to satisfy the entire lyophilization process without the aid of an additional and dedicated source of external heat, as is the practice in lyophilization plants known in the state of the art.

In fact, in the lyophilization process, the amount of heat required for the lyophilization of the product, supplied by the second heat exchanger, is substantially of an amount similar to the power extracted from the first heat exchanger.

It follows that, since the total heat dissipated by the refrigeration system is substantially equal to the cooling power extracted by the first heat exchanger for the operation of the refrigeration system plus the electrical power absorbed by the refrigeration system, the total heat to be expelled from the lyophilization plant to the external source is greater than the heat required by the lyophilization process of the product. Therefore, the second heat exchanger provides the heat necessary for the lyophilization process while the remaining heat is disposed of from the external heat exchanger towards the external source.

According to one example, during the primary drying phase, which is highly energy-intensive, the main flow regulating member conveys a first quantity of carrier fluid to be conveyed in the first branch and a second quantity of carrier fluid, greater than the first quantity of carrier fluid, to be conveyed in the second branch, so that the lyophilization plant operates in a fully loaded operating configuration. Once the primary drying phase has been completed and the secondary, less energy-intensive drying phase has begun, the main flow regulating member reduces the amount of carrier fluid conveyed in the second branch and increases the amount of carrier fluid conveyed in the first branch, so that the lyophilization plant operates in a partially loaded operating configuration.

In the present description, with reference to the second heat exchanger, the term “connected” is intended to mean that the second heat exchanger can be directly coupled to the one or more shelves or that the second heat exchanger can be indirectly coupled to the one or more shelves without thereby departing from the inventive concept underlying the present invention.

According to a first example, the second heat exchanger is operatively arranged within the containment volume and is coupled to the one or more shelves. In this example, the second heat exchanger is configured to promote thermal exchange between the carrier fluid and the containment volume so as to determine at least one yielding of heat to the one or more shelves and, consequently, to the product to be lyophilized.

Advantageously, this example guarantees a very high efficiency of the lyophilization plant.

According to a further example, the lyophilization plant comprises a secondary circuit operated by a secondary carrier fluid.

According to one example, the secondary carrier fluid may comprise glycol.

According to a further example, the secondary carrier fluid may comprise diathermic oil.

Such secondary circuit comprises an auxiliary heat exchanger arranged within the containment volume and coupled to the one or more shelves. The secondary circuit is also coupled to the second heat exchanger so as to promote a thermal exchange between the second heat exchanger and the one or more shelves and, consequently, with the product. In other words, in such an example, the secondary circuit is operatively interposed between the second heat exchanger and the one or more shelves. Functionally, by means of the second heat exchanger, the carrier fluid yields heat to the secondary carrier fluid and the secondary fluid, by means of the auxiliary heat exchanger, yields heat to the one or more shelves.

Advantageously, in this example, although the efficiency of the system decreases, the presence of the secondary circuit guarantees a structural simplification of the lyophilization plant allowing a reduction in production, installation, and maintenance costs.

In addition, in the event that the primary carrier fluid is of low environmental impact, e.g., CO2 (carbon dioxide), the secondary circuit offers the additional advantage of avoiding other pressures in the heat exchanger within the containment volume under vacuum.

According to a further aspect, structurally, the second heat exchanger and/or the auxiliary heat exchanger comprise a respective coil.

This coil can have a square, rectangular, oval, round or “D”-shaped cross section.

Advantageously, this technical feature guarantees an optimal mechanical strength of the coil that is able to withstand the mechanical stresses and pressure exerted by the carrier fluid and/or the secondary carrier fluid.

Furthermore, such a coil is preferably made of a material with high thermal conductivity.

Advantageously, this technical feature guarantees an optimal thermal exchange.

The at least one or more shelves may instead comprise respective planar plates made of aluminium.

Advantageously, this technical feature guarantees an optimal thermal exchange.

The coil of the second heat exchanger and/or the coil of the auxiliary heat exchanger can be fixed to the planar plates using a high conductivity adhesive.

Advantageously, such technical feature guarantees an optimal thermal exchange.

According to a further aspect of the present invention, the refrigeration system may comprise a sub-cooling by-pass circuit configured to convey a portion of the carrier fluid coming from the first branch and/or the second branch to the inlet of the second stage of the multistage compressor (if present) or to the inlet of the second single-stage compressor (if present).

According to one example, the sub-cooling by-pass circuit comprises a further flow regulating member of the carrier fluid configured to regulate and determine a respective amount of carrier fluid to be conveyed in input to the second stage of the multistage compressor or to the inlet of the second single-stage compressor. According to such an example, the sub-cooling by-pass circuit further comprises a sub-cooler of the aforementioned respective amount of carrier fluid to be conveyed in input to the second stage of the multistage compressor.

Advantageously, the sub-cooling by-pass circuit allows the efficiency of the lyophilization plant to be greatly improved, and in particular the efficiency of the refrigeration system, especially but not exclusively in the operating configurations at partial load.

In the case where the compression unit comprises only one single-stage compressor, the refrigeration system does not comprise the sub-cooling by-pass circuit but may comprise an additional external heat exchanger configured to cool the carrier fluid.

According to a further aspect of the present invention, the refrigeration system may comprise an overheating by-pass circuit configured to convey a portion of the carrier fluid in a high temperature gaseous state to the inlet of the first heat exchanger.

According to one example, the refrigeration system may comprise an overheating by-pass circuit configured to convey a portion of the carrier fluid coming from the second branch to the inlet of the first heat exchanger, withdrawing the carrier fluid upstream of the second heat exchanger.

According to a further example, the refrigeration system may comprise an overheating by-pass circuit configured to convey a portion of the carrier fluid coming from the first branch to the inlet of the first heat exchanger, withdrawing the carrier fluid upstream of the external heat exchanger.

According to a further example, the refrigeration system may comprise an overheating by-pass circuit configured to convey a portion of the carrier fluid coming directly from the compression unit to the inlet of the first heat exchanger.

Preferably, the overheating by-pass circuit comprises a further member for regulating the flow of the carrier fluid configured to regulate and determine a respective amount of carrier fluid to be conveyed in input to the first heat exchanger.

Advantageously, this technical feature allows the overheating by-pass circuit to be used in a phase of defrosting and removal of the frozen substance on the external walls of the first heat exchanger. In fact, the carrier fluid coming from the first branch is in a high-temperature gaseous state. Allowing the carrier fluid coming from the first branch to flow into the first heat exchanger promotes a yielding of heat from the carrier fluid to the icy substance on the walls of the first heat exchanger that determines a partial dissolution and therefore an easy removal.

Advantageously, this technical feature also allows the use of the overheating by-pass circuit to optimize the operation of the lyophilization plant and its performance. In fact, the overheating by-pass circuit can be employed as a dummy load of the first heat exchanger. In particular, the overheating by-pass circuit may be employed as a dummy load of the first heat exchanger during the aforementioned secondary drying phase. In this secondary drying phase, the lyophilization process is characterized by a much lower thermal requirement than the requirement required in the primary drying phase. Therefore, the overheating by-pass circuit is extremely advantageous in operating configurations where the refrigeration system works at partial load.

Advantageously, moreover, the overheating by-pass circuit is extremely advantageous since it allows avoiding turning off the compressor.

According to a further aspect, the refrigeration system may comprise an auxiliary circuit for regulating the flow of the carrier fluid interposed between the first heat exchanger and the compression unit. According to one example, such auxiliary flow regulating expansion circuit comprises a carrier fluid expansion member.

Advantageously, the auxiliary flow regulating circuit allows a further optimization of the operation of the lyophilization plant and an improvement of its efficiency. In particular, the auxiliary flow regulating circuit may be employed to ensure that the carrier fluid in input to the compression unit has a correct pressure value.

This use is extremely useful where the aforementioned overheating by-pass circuit is also present.

According to a further aspect of the present invention, the refrigeration system may comprise a freezing circuit configured to convey to the inlet of the second heat exchanger a portion or all of the carrier fluid subjected to lamination so that such portion of carrier fluid can cool and freeze the product arranged on the one or more shelves.

The freezing circuit may include a first by-pass branch and a second by-pass branch.

According to one example, the first by-pass branch branches upstream of the aforesaid expansion unit and connects to the second branch upstream of the second heat exchanger. The first by-pass branch comprises a secondary expansion member, for example an expansion valve, configured to conduct a lamination on the carrier fluid. In particular, the secondary expansion member is configured to promote a decrease in pressure of the carrier fluid and to promote a decrease in temperature of the carrier fluid.

According to a further example, the first by-pass branch branches downstream of the aforementioned expansion unit and connects to the second branch upstream of the second heat exchanger without a secondary expansion member. The first by-pass branch comprises a flow regulating member. According to this example, there is also provided a further flow regulating member arranged downstream of the expansion unit and downstream of the branching of the first by-pass branch. Such further flow regulating member is configured to send a portion or all of the carrier fluid exiting the expansion unit on the first by-pass branch.

The second by-pass branch branches off from the second branch downstream of the second heat exchanger and connects upstream of the compression unit. Such second by-pass branch comprises a respective flow regulating member.

Furthermore, an additional flow regulating member can be provided on the second branch downstream of the branching of the second by-pass branch.

At the functional level, the carrier fluid enters the first by-pass branch of the freezing circuit and is laminated by the secondary expansion member or enters the first by-pass branch of the freezing circuit already laminated by the expansion unit. The laminated carrier fluid passes inside the second heat exchanger and causes cooling of the product on the one or more shelves. Outgoing from the second heat exchanger, the carrier fluid, by means of the regulation of the flow regulating members, is sent directly to the compression unit.

Advantageously, this technical feature allows the product to be frozen directly on the one or more shelves inside the lyophilization tank.

According to a further aspect, the lyophilization plant may comprise a control unit connected to the refrigeration system and a measuring apparatus connected to the control unit and comprising a plurality of sensors, operatively active on the lyophilization tank and/or the refrigeration system.

In particular, the control unit is configured to determine an operation of at least the main flow regulating member according to a plurality of measurements carried out by the measuring apparatus.

According to one example, the control unit is further connected to the lyophilization tank and is configured to determine an operation of the lyophilization tank.

According to one example, the control unit is also configured to determine an operation of the expansion unit.

According to one example, the control unit is also configured to determine an operation of the compression unit.

According to one example, the control unit is further configured to determine an operation of the secondary circuit, if present.

According to one example, the control unit is further configured to determine an operation of the sub-cooling by-pass circuit, if present.

According to one example, the control unit is further configured to determine an operation of the auxiliary flow regulating circuit, if present.

According to a further aspect, the plurality of sensors comprises sensors adapted to measure temperature and pressure values inside the lyophilization plant.

For example, the plurality of sensors may comprise a first temperature sensor adapted to measure a second temperature value of the carrier fluid inside the second branch, preferably upstream of the second heat exchanger.

For example, the plurality of sensors may comprise a second temperature sensor adapted to measure a second temperature value of the carrier fluid inside the second branch, preferably downstream of the second heat exchanger.

For example, the plurality of sensors may comprise a first pressure sensor adapted to measure a first pressure value of the carrier fluid inside the second branch, preferably upstream of the second heat exchanger.

For example, the plurality of sensors may comprise a second pressure sensor adapted to measure a second pressure value of the carrier fluid inside said second branch, preferably downstream of the second heat exchanger.

For example, the plurality of sensors may comprise a third pressure sensor adapted to measure a third pressure value inside the lyophilization tank.

In a preferred but non-limiting manner, the control unit comprises all sensors listed above.

Furthermore, the control unit may comprise further sensors configured for example to check that the pressure inside the refrigeration circuit does not exceed critical values, that the relative pressures between the plurality of heat exchangers do not exceed critical values, that the carrier fluid at the inlet of the compression unit is completely in the gaseous state, that the compression unit operates between a certain range of pressure values.

Advantageously, the control unit and the plurality of sensors allow an autonomous and optimal regulating of the lyophilization plant so as to constantly operate in an extremely high-performance operating configuration and so as to avoid malfunctions of the lyophilization plant itself.

Further features and advantages of the present invention will become more apparent from the indicative, and therefore non-limiting, description of one or more embodiments of a lyophilization plant.

Such description will be set out hereinafter with reference to the accompanying drawings, which are provided solely for illustrative purposes and are therefore non-limiting in scope, wherein:

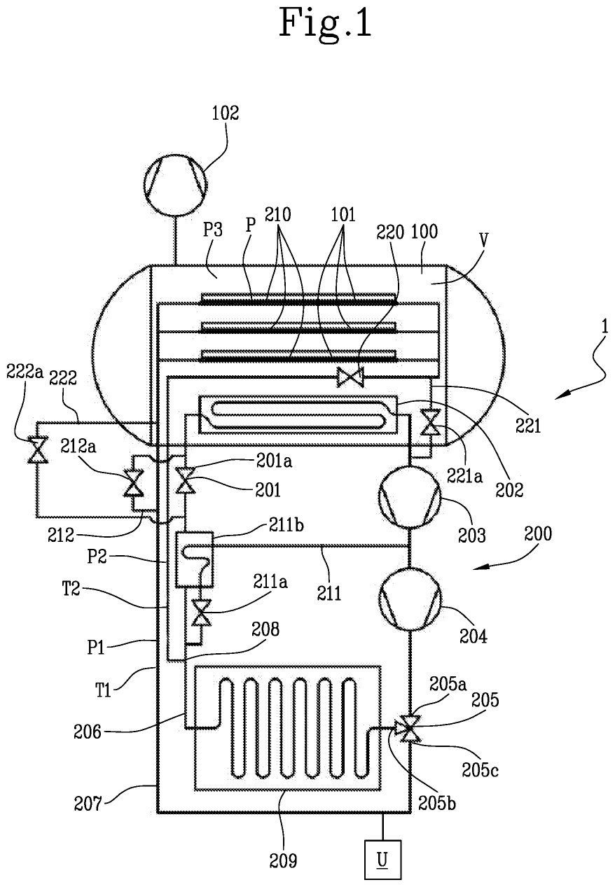

FIG. 1 is a schematic view of a first embodiment, exemplary and therefore non-limiting, of a lyophilization plant in accordance with the present invention;

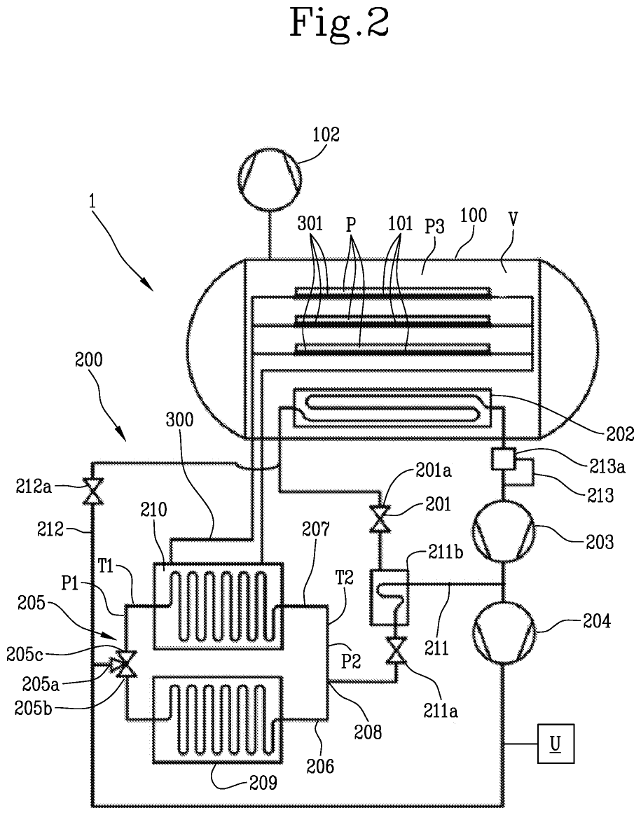

FIG. 2 is a schematic view of a second embodiment, exemplary and therefore non-limiting, of a lyophilization plant in accordance with the present invention;

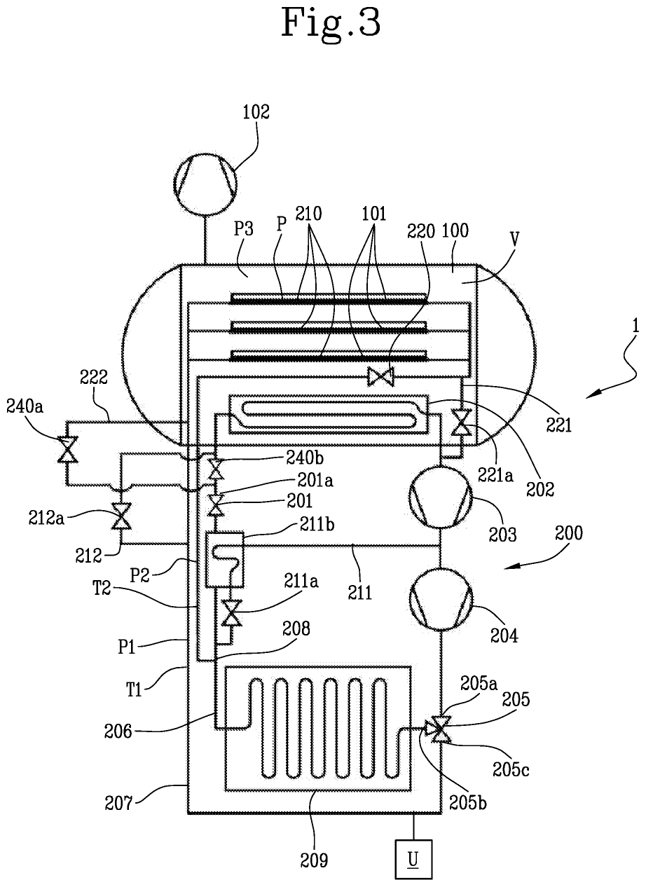

FIG. 3 is a schematic view of a third embodiment, exemplary and therefore non-limiting, of a lyophilization plant in accordance with the present invention.

With reference to the accompanying drawings, the reference numeral “1” indicates a lyophilization plant in accordance with the present invention.

The lyophilization plant 1 is configured to remove a substance from a product “P” to be lyophilized.

Preferably, such substance is water.

Preferably, moreover, the product “P” is any organic matter containing water.

For example, the product “P” can be any organic matter which is used, for example, in the pharmaceutical or food sectors.

The lyophilization plant 1 comprises a lyophilization tank 100 and a refrigeration system 200.

The lyophilization tank 100 has a containment volume “V” and comprises one or more shelves 101 operatively arranged inside the containment volume “V” and configured to support said product “P”.

Preferably, the one or more shelves 101 comprise respective plates made of aluminium or another material with good thermal conductivity.

Preferably, moreover, the lyophilization plant 1 comprises a plurality of trays, not illustrated in the attached figures, which can be inserted in the containment volume “V” so as to facilitate the transport and positioning of the product “P” inside the lyophilization tank 100.

The lyophilization tank 100 further includes a vacuum pump 102 configured to maintain the containment volume “V” in a vacuum condition.

Preferably, the pressure value within the lyophilization tank 100 is maintained at a pressure value comprised between 0.01 mbar and 0.6 mbar.

The refrigeration system 200 is a closed-loop system, coupled to the lyophilization tank 100 and operating by means of a carrier fluid.

Preferably, but not limitingly, the carrier fluid comprises R404A.

The refrigeration system 200 comprises a carrier fluid expansion unit 201. Preferably, the expansion unit 201 comprises a lamination valve 201a.

The refrigeration system 200 comprises a first heat exchanger 202, arranged downstream of the expansion unit 201 and operatively inserted in the containment volume “V”.

The first heat exchanger 202 is configured to promote a thermal exchange between the carrier fluid and the containment volume “V” so as to determine at least one cooling of the containment volume “V”.

The refrigeration system 200 comprises a compression unit 203, 204 of the carrier fluid, arranged downstream of the first heat exchanger 202.

The compression unit 203, 204 comprises a multistage compressor having a first stage 203 and a second stage 204.

The refrigeration system 200 comprises a main flow regulating member 205 of the carrier fluid, arranged downstream of the compression unit 203, 204.

Preferably, such main flow regulating member 205 comprises a three-way valve.

The main flow regulating member 205 has an inlet opening 205a in fluid communication with the compression unit 203, 204, a first discharge opening 205b connected to a first branch 206 and a second discharge opening 205c connected to a second branch 207, parallel to the first branch 206.

The first and the second branch 206, 207 are connected in a connecting node upstream of the compression unit. Preferably, the first and the second branch 206, 207 are connected in a connecting node 208 upstream of the expansion unit 201.

The first branch 206 comprises an external heat exchanger 209 configured such that the carrier fluid yields heat to an external thermal source.

The external heat exchanger 209 may be equipped with electric fans.

Alternatively, the external heat exchanger 209 is cooled by evaporative spray or water spray with optional electric fans.

The external heat exchanger 209 may be equipped with electric fans.

Alternatively, the external heat exchanger 209 is cooled by evaporative spray or water spray with optional electric fans.

The second branch 207 comprises a second heat exchanger 210, connected to the one or more shelves 101 and configured such that the carrier fluid yields heat to the one or more shelves 101.

The main flow regulating member 205 is configured to regulate and determine respective amounts of carrier fluid conveyed in the first and in the second branch 206, 207 so as to obtain a plurality of operating configurations of the lyophilization plant 1.

FIG. 1 shows a first exemplary and therefore non-limiting embodiment of the lyophilization plant 1.

In such an embodiment, the second heat exchanger 210 is operatively arranged within the containment volume “V” and is coupled to the one or more shelves 101. In particular, the second heat exchanger 210 is configured to promote a thermal exchange between the carrier fluid and the containment volume “V” so as to determine at least one yielding of heat to the one or more shelves 101.

In such an embodiment, the second heat exchanger 210 comprises a coil having a square or rectangular section and made of aluminium. The coil is attached to the aforementioned planar plates by means of an adhesive with high thermal conductivity.

FIG. 2 shows a second exemplary and therefore non-limiting embodiment of the lyophilization plant 1.

In such an embodiment, the lyophilization plant 1 comprises a secondary circuit 300 operating by means of a secondary carrier fluid and comprising an auxiliary heat exchanger 301 arranged within the containment volume “V” and coupled to the one or more shelves 101. In particular, the secondary circuit 300 is further coupled to the second heat exchanger 210 so as to promote a thermal exchange between the carrier fluid and the one or more shelves 101.

As can be seen from the accompanying figures, moreover, the refrigeration system 200 comprises a sub-cooling by-pass circuit 211 configured to convey a portion of the carrier fluid coming from the first branch 206 and the second branch 207 to the inlet of the second stage 204 of the multistage compressor.

Preferably, the sub-cooling by-pass circuit 211 comprises a further flow regulating member 211a of the carrier fluid configured to regulate and determine a respective amount of carrier fluid to be conveyed in input to the second stage 204 of the multistage compressor and a sub-cooler 211b of a respective amount of carrier fluid to be conveyed in input to the second stage 204 of the multistage compressor.

As can be seen from FIG. 1, the refrigeration system 1 comprises an overheating by-pass circuit 212 configured to convey a portion of the carrier fluid coming from the second branch 207 to the inlet of the first heat exchanger 202, withdrawing the carrier fluid upstream of the second heat exchanger 210.

As can be seen in FIGS. 1 and 3, moreover, the refrigeration system 1 comprises a freezing circuit 221, 222 configured to convey to the inlet of the second heat exchanger 210 a portion or all of the carrier fluid subjected to lamination so that such portion of carrier fluid can, if required, cool and freeze the product “P” arranged on the one or more shelves 101. In particular, the freezing circuit 221, 222 comprises a first by-pass branch 222 and a second by-pass branch 221.

FIG. 1 shows a first embodiment of the first by-pass branch 222 of the freezing circuit 221, 222. In such an embodiment, the first by-pass branch 222 branches upstream of the aforementioned expansion unit 201 and connects to the second branch 207 upstream of the second heat exchanger 210. The first by-pass branch 222 comprises a secondary expansion member 222a, e.g., an expansion valve, configured to conduct a lamination on the carrier fluid. In particular, the secondary expansion member 222a is configured to promote a decrease in pressure of the carrier fluid and to promote a decrease in temperature of the carrier fluid.

An alternative embodiment of the first by-pass branch 222 of the freezing circuit 221, 222 is illustrated in FIG. 3. In such an embodiment, the first by-pass branch 222 branches downstream of the aforementioned expansion unit 201 and connects to the second branch 207 upstream of the second heat exchanger 210. In such an embodiment, the first by-pass branch 222 does not comprise a secondary expansion member. In fact, the first by-pass branch 222 comprises a flow regulating member 240a. In addition, a further flow regulating member 240b is provided arranged downstream of the expansion unit 201 and downstream of the branching of the first by-pass branch 222. The flow regulating members 240a, 240b are configured to regulate the supply of carrier fluid into the first by-pass branch 222.

As can be seen from FIGS. 1 and 3, the second by-pass branch 221 branches off from the second branch 207 downstream of the second heat exchanger 210 and connects upstream of the compression unit 203, 204. Such second by-pass branch 221 comprises a respective flow regulating member 221a.

Furthermore, a further flow regulating member 220 is provided on the second branch 207 downstream of the branching of the second by-pass branch 221.

As can be seen from the figures, the refrigeration system 1 comprises an overheating by-pass circuit 212 configured to convey a portion of the carrier fluid coming directly from the compression unit 203, 204 to the inlet of the first heat exchanger 202.

Preferably, the overheating by-pass circuit 212 comprises a further flow regulating member 212a of the carrier fluid configured to regulate and determine a respective amount of carrier fluid to be conveyed in input to the first heat exchanger 202.

As can be seen from the attached figures, the refrigeration system 200 comprises an auxiliary circuit for regulating the flow 213 of the carrier fluid interposed between the first heat exchanger 202 and the compression unit 203, 204.

The auxiliary flow regulating circuit 213 comprises a carrier fluid expansion member 213a, such as an expansion valve.

As can be seen in the figures, the lyophilization plant 1 comprises a control unit “U” connected to the refrigeration system 200 and a measuring apparatus connected to said control unit “U” and comprising a plurality of sensors T1, T2, P1, P2, P3, operatively active on the lyophilization tank 100 and/or the refrigeration system 200.

In particular, the control unit “U” is configured to determine an operation of at least the main flow regulating member 205 according to a plurality of measurements carried out by the measuring apparatus.

Preferably, the plurality of sensors T1, T2, P1, P2, P3 comprise a first temperature sensor T1, a second temperature sensor T2, a first pressure sensor P1, a second pressure sensor P2 and a third pressure sensor P3.

The first temperature sensor T1 is adapted to measure a first temperature value of the carrier fluid inside the second branch 207, upstream of the second heat exchanger 210

The second temperature sensor T2 is adapted to measure a second temperature value of the carrier fluid inside the second branch 207, downstream of the second heat exchanger 210.

The first pressure sensor P1 is adapted to measure a first pressure value of the carrier fluid inside the second branch 207, upstream of the second heat exchanger 210.

The second pressure sensor P2 is adapted to measure a second pressure value of the carrier fluid inside the second branch 207, downstream of the second heat exchanger 210.

The third pressure sensor P3 is adapted to measure a third pressure value inside the lyophilization tank 100.

Hereinafter, an operation of the control unit “U” implemented for the embodiment of FIG. 1 will be described by way of non-limiting example.

The control unit “U” regulates the operation of the main flow regulating member 205 so as to determine the respective amounts of carrier fluid to be conveyed in the first branch 206, and then to the external heat exchanger 209, and to the second branch 207, and then to the second heat exchanger 210.

The control unit “U” receives, from the plurality of sensors T1, T2, P1, P2, P3, temperature and pressure measurements detected upstream and downstream of the second heat exchanger 210 respectively from the first temperature sensor T1, from the second temperature sensor T2, from the first pressure sensor P1 and from the second pressure sensor P2.

An actual value of a pressure drops within the second heat exchanger 210 is then calculated and that value is compared with a reference value of a pressure drop.

If the actual value is greater than the reference value, the control unit “U” manoeuvres the main flow regulating member 205 so as to reduce the portion of carrier fluid conveyed in the second branch 207, reducing the value of the pressure drop.

Furthermore, the control unit “U” receives from the plurality of sensors T1, T2, P1, P2, P3 a pressure measurement detected inside the lyophilization tank 100, from the third pressure sensor P3.

This actual pressure value inside the lyophilization tank 100 is compared with a reference value of the pressure inside the lyophilization tank 100.

If the actual value is greater than the reference value, the control unit “U” manoeuvres the main flow regulating member 205 so as to reduce the portion of carrier fluid conveyed in the second branch 207. It follows that the reduction of the carrier fluid conveyed in the second branch 207 causes a reduction of thermal power to the one or more shelves 101. In this way, the amount of evaporated substance and thus the pressure inside the lyophilization tank 100 decreases.

Conversely, if the actual value is lower than the reference value, the control unit “U” manoeuvres the main flow regulating member 205 so as to increase the portion of carrier fluid conveyed in the second branch 207.

If this actual value is greater than the reference value,

If this actual value is greater than the reference value, in the secondary drying phase the actual pressure value inside the lyophilization tank is lower than the reference value indicating that the primary drying phase has ended.

In such a condition, the control unit “U” manoeuvres the main flow regulating member 205 so as to increase the portion of carrier fluid conveyed in the first branch 206 so as to increase the amount of heat yielded to the external source.

The control unit “U” also adjusts the temperature of the shelves on which the trays are placed by adjusting the thermal power extracted in the heat exchanger 209. In particular, the heat exchanger 209 can be equipped with variable speed fans that are controlled by the unit “U” to maintain a constant pressure inside the second branch 207, in particular in the second heat exchanger 210 (substantially measured by the second pressure sensor P2), corresponding to a certain temperature value of the saturated vapor. If the pressure within the second branch 207, in particular within the second heat exchanger 210, is too high despite the fans acting on the external heat exchanger 209 being at a maximum, the control unit “U” manoeuvres the main flow regulating member 205 to further reduce the portion of fluid conveyed in the second branch 207, until the temperature within the second branch 207, downstream of the second heat exchanger 210 (measured substantially by the second temperature sensor T2), is returned to nominal values by sub-cooling the fluid within the trays.

The present invention achieves the proposed objects, eliminating the drawbacks identified by the prior art: in this regard, it should be noted first of all that the lyophilization plant 1 as described and/or claimed ensures a reduced consumption of energy while maintaining a compact and simplified structure. It should also be noted that the lyophilization plant 1 is extremely efficient.

These results are achieved by the presence of the first and second branches 206, 207 and of the main flow regulating member 205 that allow the refrigeration system 200 to be used also to provide heat to the lyophilization tank 100 at least in the primary drying and secondary drying phases so as not to have to use an additional and dedicated external heat source, as is the practice in lyophilization plants known in the state of the art.

Advantageously, moreover, due to the reduced energy consumption, it is possible to reduce the production costs and therefore to reduce the sales prices of the lyophilized product “P”. It follows that the lyophilization plant 1 can be used for a wide variety of products “P” that are becoming available on the market.

It should also be noted that such results are also achieved due to the presence of the control unit “U” and of the plurality of sensors T1, T2, P1, P2, P3 that allow an autonomous and optimal regulating of the operating configurations of the lyophilization plant 1 as well as of the various accessory circuits 211, 212, 213 that allow a precision regulating of the operation of the lyophilization plant 1.

1. A lyophilization plant configured to remove a substance from a product to be lyophilized, comprising:
a lyophilization tank having a containment volume and comprising one or more shelves operatively arranged inside the containment volume and configured to support said product;
a closed-loop refrigeration system, coupled to the lyophilization tank and operating by means of a carrier fluid; said refrigeration system comprising:
an expansion unit of the carrier fluid;
a first heat exchanger, arranged downstream of the expansion unit and operatively inserted in the containment volume; said first heat exchanger being configured to promote a thermal exchange between the carrier fluid and the containment volume;
a compression unit of the carrier fluid, arranged downstream of the first heat exchanger;
a main flow regulating member of the carrier fluid, arranged downstream of the compression unit and having an inlet opening in fluid communication with the compression unit, a first discharge opening connected to a first branch and a second discharge opening connected to a second branch, parallel to the first branch; said first branch and said second branch being connected in a connection node upstream of said compression unit;
wherein the first branch comprises an external heat exchanger configured so that the carrier fluid yields heat to an external thermal source; and wherein the second branch comprises a second heat exchanger, connected to said one or more shelves and configured so that the carrier fluid yields heat to said one or more shelves;
said main flow regulating member being configured to regulate and determine respective amounts of carrier fluid conveyed in said first branch and in said second branch so as to obtain a plurality of operating configurations of the lyophilization plant.

2. The lyophilization plant according to claim 1, wherein said main flow regulating member comprises a three-way valve.

3. The lyophilization plant according to claim 1, wherein said second heat exchanger is operatively arranged inside the containment volume and is coupled to said one or more shelves; said second heat exchanger being configured to promote a heat exchange between the carrier fluid and the containment volume so as to determine at least one yielding of heat to said one or more shelves.

4. The lyophilization plant according to claim 1, comprising a secondary circuit operating by means of a secondary carrier fluid and comprising an auxiliary heat exchanger arranged inside the containment volume and coupled to said one or more shelves; said secondary circuit also being coupled to said second heat exchanger so as to promote a thermal exchange between said carrier fluid and said one or more shelves.

5. The lyophilization plant according to claim 1, wherein said compression unit comprises a multistage compressor having a first stage and at least a second stage.

6. The lyophilization plant according to claim 5, wherein said refrigeration system comprises a sub-cooling by-pass circuit configured to convey to the inlet of said second stage of said multistage compressor a portion of said carrier fluid coming from said first branch and/or from said second branch; preferably said sub-cooling by-pass circuit comprising a further flow regulating member of the carrier fluid configured to regulate and determine a respective amount of carrier fluid to be conveyed in input to said second stage of said multistage compressor and a sub-cooler of the respective amount of carrier fluid to be conveyed in input to said second stage of said multistage compressor.

7. The lyophilization plant according to claim 1, wherein said refrigeration system comprises an overheating by-pass circuit configured to convey to the inlet of said first heat exchanger a portion of said carrier fluid coming from said second branch, withdrawing said carrier fluid upstream of said second heat exchanger; preferably said overheating by-pass circuit comprising a further flow regulating member of the carrier fluid configured to regulate and determine a respective amount of carrier fluid to be conveyed in input to said first heat exchanger.

8. The lyophilization plant according to any one claim 1, wherein said refrigeration system comprises an auxiliary flow regulating circuit of said carrier fluid interposed between said first heat exchanger and said compression unit; said auxiliary flow regulating circuit comprising an expansion member of the carrier fluid.

9. The lyophilization plant according to claim 1, wherein said second heat exchanger and/or said auxiliary heat exchanger comprises a coil having square or rectangular section and made of aluminium and wherein said one or more shelves comprise respective planar plates made of aluminium; said coil being fixed to said planar plates by means of a high-conductivity adhesive terminate.

10. The lyophilization plant according to claim 1, comprising a control unit connected to said refrigeration system and a measuring apparatus connected to said control unit and comprising a plurality of sensors, operatively active on said lyophilization tank and/or said refrigeration system;
said control unit being configured to determine an operation of at least said main flow regulating member according to a plurality of measurements carried out by said measuring apparatus.

11. The lyophilization plant according to claim 10, wherein said plurality of sensors comprise at least one, preferably all, of:
a first temperature sensor adapted to measure a second temperature value of the carrier fluid inside said second branch, preferably upstream of said second heat exchanger;
a second temperature sensor adapted to measure a second temperature value of the carrier fluid inside said second branch, preferably downstream of said second heat exchanger;
a first pressure sensor adapted to measure a first pressure value of the carrier fluid inside said second branch, preferably upstream of said second heat exchanger;
a second pressure sensor adapted to measure a second pressure value of the carrier fluid inside said second branch, preferably downstream of said second heat exchanger;
a third pressure sensor adapted to measure a third pressure value inside the lyophilization tank.

12. The lyophilization plant according to claim 1, comprising a freezing circuit configured to convey at the input of the second heat exchanger a portion of said carrier fluid so as to promote a cooling of the one or more shelves.
